(19) United States
(12) Patent Application Publication
(10) Pub. No.: US 2013/0027422 A1
(43) Pub. Date: Jan. 31, 2013

(54) EXTENDING A DISPLAY AREA OF A COMPUTER

(71) Applicant: Sean Kennedy, San Diego, CA (US)

(72) Inventor: Sean Kennedy, San Diego, CA (US)

(73) Assignee: SONY CORPORATION, Tokyo (JP)

(21) Appl. No.: 13/193,444

(22) Filed: Jul. 28, 2011

(51) Int. Cl. G09G 5/00

(52) U.S. Cl. 345/619

(57) ABSTRACT

Embodiments generally relate to extending a display area of a computer. In one embodiment, a method includes detecting a first position of a secondary display relative to a primary display. The method further includes detecting a second position of the secondary display. The method further includes adjusting one or more settings of the secondary display based on the second position, where the adjusting causes the secondary display to be a continuation of the primary display.

### BACKGROUND

A computer user might sometimes utilize extended desktop functions of the user's notebook computer to attach an external monitor in order to have full-size views of multiple applications and processes. If an external monitor is not available, a user who is reliant on having an external monitor needs to change the user's computer usage in order to work with one monitor.

### SUMMARY

Embodiments generally relate to extending a display area of a computer. In one embodiment, a method includes detecting a first position of a secondary display relative to a primary display. The method further includes detecting a second position of the secondary display. The method further includes adjusting one or more settings of the secondary display based on the second position, where the adjusting causes the secondary display to be a continuation of the primary display.

### BRIEF DESCRIPTION OF THE DRAWINGS

FIG. 1 illustrates a perspective view of an example computer having an extendable display area, according to one embodiment.

FIG. 2 illustrates a top view of a secondary display of the computer of FIG. 1 in a closed position, according to one embodiment.

FIG. 3 illustrates a top view of the secondary display of the computer of FIG. 1 in an open position, according to one embodiment.

FIG. 4 illustrates a block diagram of an example computer system, which may be used to implement the embodiments described herein.

FIG. 5 illustrates an example simplified flow diagram for extending a display area of a computer, according to one embodiment.

FIG. 6 illustrates a perspective view of an example computer having an extendable display area, according to one embodiment.

FIG. 7 illustrates a top view of secondary displays of the computer of FIG. 6 in closed positions, according to one embodiment.

FIG. 8 illustrates a top view of the secondary displays of the computer of FIG. 6 in open positions, according to one embodiment.

FIG. 9 illustrates a front view of an example extendable display area, according to one embodiment.

FIG. 10 illustrates a top view of a secondary display of the display area of FIG. 9 in a closed position, according to one embodiment.

FIG. 11 illustrates a top view of the secondary display of the display area of FIG. 9 in an open position, according to one embodiment.

FIG. 12 illustrates a front view of an example extendable display area, according to one embodiment.

FIG. 13 illustrates a top view of secondary displays of the display area of FIG. 12 in closed positions, according to one embodiment.

FIG. 14 illustrates a top view of the secondary displays of the display area of FIG. 12 in open positions, according to one embodiment.

FIG. 15 illustrates a front view of an example computer having an extendable display area, according to one embodiment.

FIG. 16 illustrates a front view of an example computer having an extendable display area, according to one embodiment.

FIG. 17 illustrates a front view of an example computer having an extendable display area, according to one embodiment.

### DETAILED DESCRIPTION

Embodiments described herein extend a display area of a computer by providing one or more secondary displays that augment a primary display. In one embodiment, the primary display and one more secondary displays constitute the display area, where the combination of the primary display and one or more secondary displays in effect creates one continuous display. In one embodiment, a method includes detecting a first position of one or more secondary displays relative to a primary display. In some embodiments, the secondary displays may be foldable or pocketed displays, which could be opened to provide the user with an attached extended desktop. The method further includes detecting second positions of the respective secondary displays, and then adjusting one or more settings of the secondary displays based on the second positions, where the adjusting causes the one or more secondary displays to be a continuation of the primary display. As a result, the combination of displays provides a user with one seamless and contiguous display area.

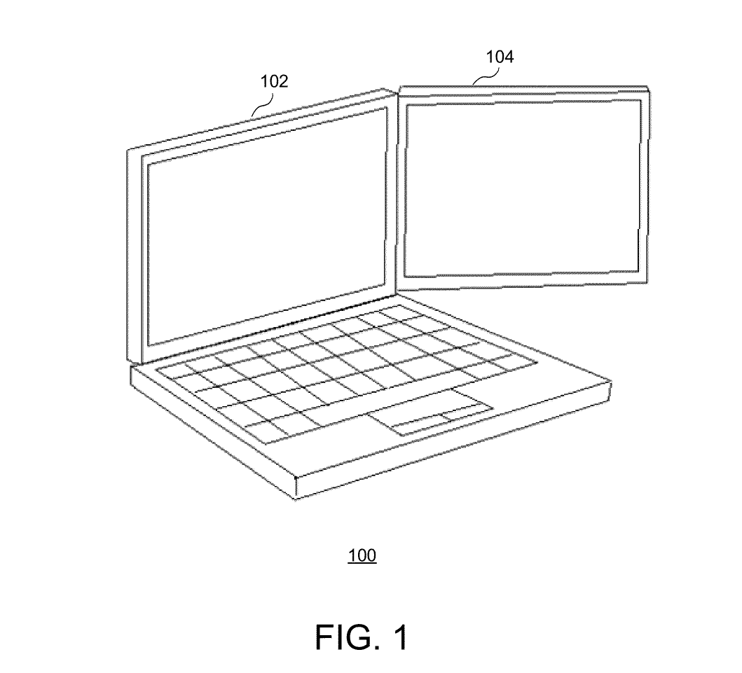

FIG. 1 illustrates a perspective view of an example computer 100 having an extendable display area, according to one embodiment. In one embodiment, computer 100 includes a primary display 102 and a secondary display 104. In the embodiments described herein, the term secondary display may also be referred to as an auxiliary display in that the secondary display augments the primary display to provide a user with one continuous display (e.g., display area). The terms secondary and auxiliary are used interchangeably.

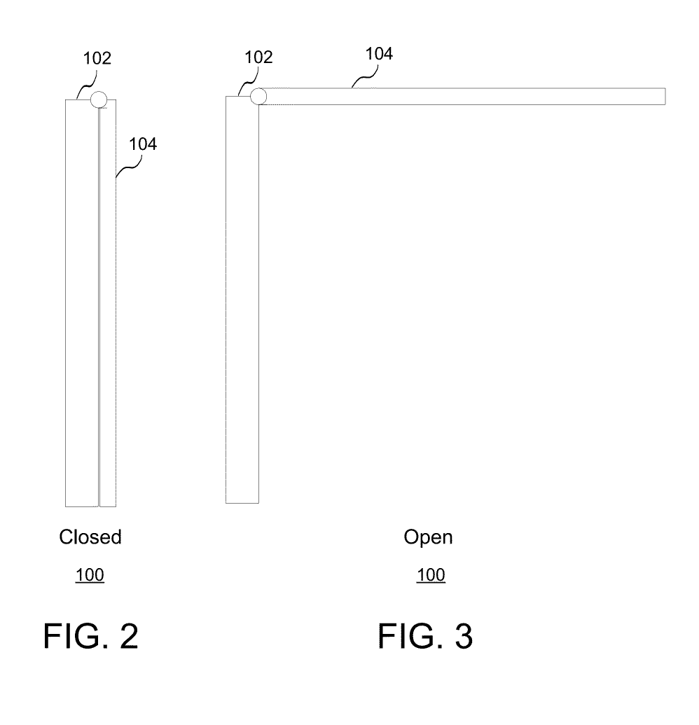

FIG. 2 illustrates a top view of primary and secondary displays 102 and 104 of computer 100 of FIG. 1, where secondary display 104 is in a closed position, according to one embodiment. FIG. 3 illustrates a top view of primary and secondary displays 102 and 104 of computer 100 of FIG. 1, where secondary display 104 is in an open position, according to one embodiment.

In one embodiment, the combination of primary display 102 and secondary display 104 may be referred to as a single-panel bi-fold display. In one embodiment, secondary display 104 folds across primary display 102 when in a closed position. In this embodiment, the user opens secondary display 104 to use the computer. In one embodiment, the display positions and dimensions are fixed variables, which the screen management application 410 may take into account when creating the extended work area. Note that the terms display area, workspace, and work area are used interchangeably. Aspects of the relative positions of primary and secondary displays 102 and 104 are described in more detail below.

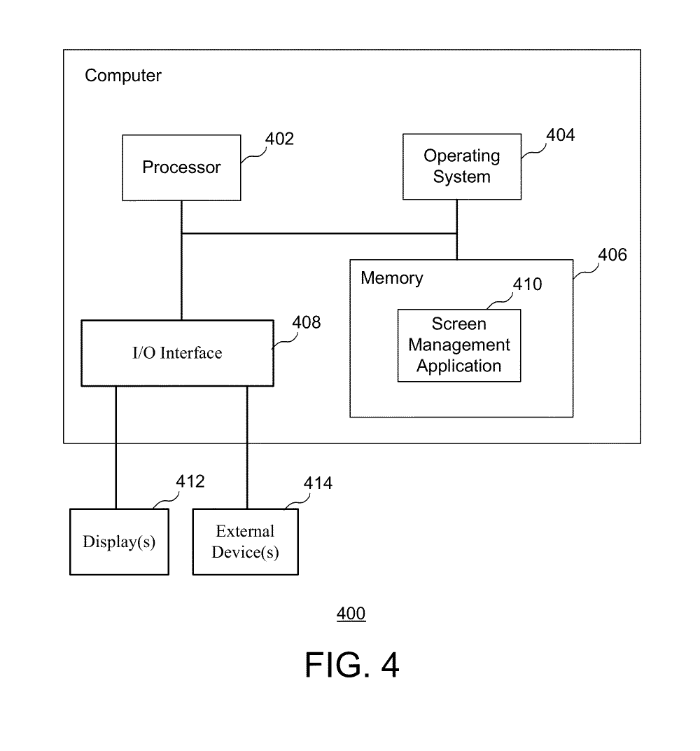

FIG. 4 illustrates a block diagram of an example computer system 400, which may be used to implement the embodiments described herein. In one embodiment, computer 400 includes a user processor 402, an operating system 404, a memory 406, and an input/output (I/O) interface 408, all of which are connected via any one or more suitable buses. Memory 406 may be any storage location or computer-readable storage medium. In one embodiment, memory 406 stores at least one program product such as a screen management application 410 that provides instructions that enable a processor to perform the functions of the embodiments described herein. While processor 402 is described as performing the functions as described in the embodiments herein, any suitable processor or processors associated with computer 400 may perform the functions described. Computer 400 may communicate with one or more displays 412, as well as various external devices 414 such as a keyboard, a pointing device, etc., via I/O interface 408.

In other embodiments, computer 400 may not have all of the components listed and/or may have other elements instead of, or in addition to, those listed above. For ease of illustration, FIG. 4 shows one block for each of processor 402, operating system 404, memory 406, I/O interface 408, displays 412, and external devices 414. These blocks 402, 404, 406, 408, 412, and 414 may represent multiple processors, operating systems, memories, I/O interfaces, displays, and external devices.

Although embodiments disclosed herein are described in the context of displays for notebook computers, embodiments may apply to displays for other types of computers such as desktop computers, personal digital assistants (PDAs), mobile phones, smart phones, etc.

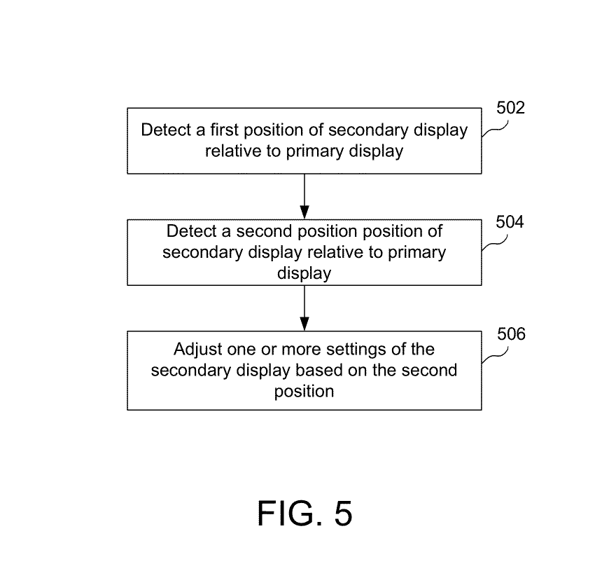

FIG. 5 illustrates an example simplified flow diagram for extending a display area of a computer, according to one embodiment. Referring to FIGS. 1 through 4, in one embodiment, processor 402 automatically activates screen management application 410 when computer 400 boots up, or at any other suitable time after computer 400 boots up. In one embodiment, a user may manually activate screen management application 410. In a specific embodiment, the user may activate screen management application 410 by selecting a button such as a “large screen format” button.

The process is initiated in block 502, where screen management application 410 detects a first position of secondary display 104. In one embodiment, the first position may be relative to primary display 102. In one embodiment, the first position is a closed position as shown in FIG. 2.

In block 504, screen management application 410 detects a second position of secondary display 104. In one embodiment, the second position may be relative to the first position or to primary display 102. In one embodiment, the second position is an open position as shown in FIG. 3. In one embodiment, screen management application 410 activates secondary display 104 when screen management application 410 detects that secondary display 104 moves from the first/closed position (e.g., to the second/open position or to any other open position that is different from the first/closed position).

For ease of illustration, one open position is described in this particular example embodiment. As described in other embodiments below, the second/open position may represent different gradations of open positions. As described in more detail below, in some embodiments, one or more open positions of any given secondary display may be based on one or more reference points associated with the primary display.

In block 506, screen management application 410 adjusts one or more settings of the secondary display 104 based on the second position. In one embodiment, the adjusting causes the secondary display 104 to be a continuation of primary display 102. This embodiment and other embodiments described herein are particularly useful to users who rely on having an extended desktop, such as professional CAD users who need a very wide display to view structural layouts.

In one embodiment, the adjusted settings may include the following examples. In one embodiment, screen management application 410 adjusts extended desktop settings. In one embodiment, screen management application 410 adjusts one or more software applications that the user is using to continuously span across both the primary display and the secondary display. In one embodiment, screen management application 410 adjusts the user interface (UI) to match the extended desktop settings. As a result, the primary display and the secondary display both function together as one continuous display. As such, the combination of displays provides a user with one seamless and contiguous workspace.

In one embodiment, the workspace may be centered on the primary display and the extended desktop stretches outward from the primary display to the one or more secondary displays. In one embodiment, the height of the workspace may be the height of the primary display, even if the height of the secondary display is smaller than that of the primary display. This assumes that the workable area may spill over the top and bottom edges of the secondary display, which would be expected if the displayed content matches seamlessly along the vertical edge between the displays.

In one embodiment, in cases where the primary and secondary displays have bezels (e.g., outside frame areas surrounding the glass of the displays), screen management application 410 accounts for the bezel in order to keep the primary display and the secondary display functioning together as one continuous display. For example, screen management application 410 causes a given user interface or application used by the user to end at the edge of the primary display and begin at the neighboring edge of the secondary display(s). In one embodiment, the primary and secondary displays have bezels that are transparent in order to keep the primary display and the secondary display functioning together as one continuous display. For example, in one embodiment, pixels of the displays are visible through the transparent bezels. These embodiments provide a user with one seamless and contiguous workspace. Such transparent bezels enable the user to have more visible contiguous workspace between the primary and secondary displays. In another embodiment, the inner edge of the secondary display may also be transparent to enhance the amount of workspace. In the embodiments described herein, the setup of the extended desktop, including the adjusted one or more settings, is automatic upon opening the secondary display(s).

While the embodiments above are described in the context of a single panel bi-fold, other display embodiments are possible, as described in more detail below. The embodiments described in FIGS. 4 and 5 also apply to the embodiments described below.

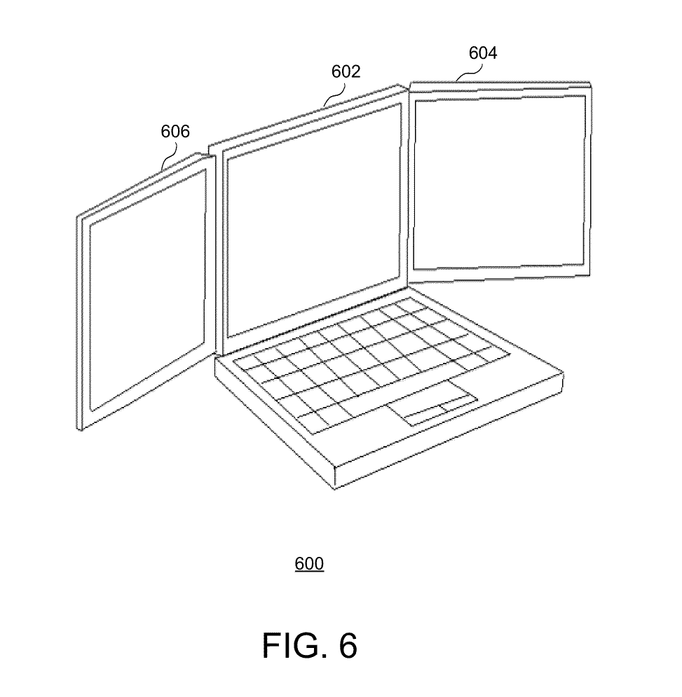

FIG. 6 illustrates a perspective view of an example computer 600 having an extendable display area, according to one embodiment. In one embodiment, computer 600 includes a primary display 602 and secondary displays 604 and 606.

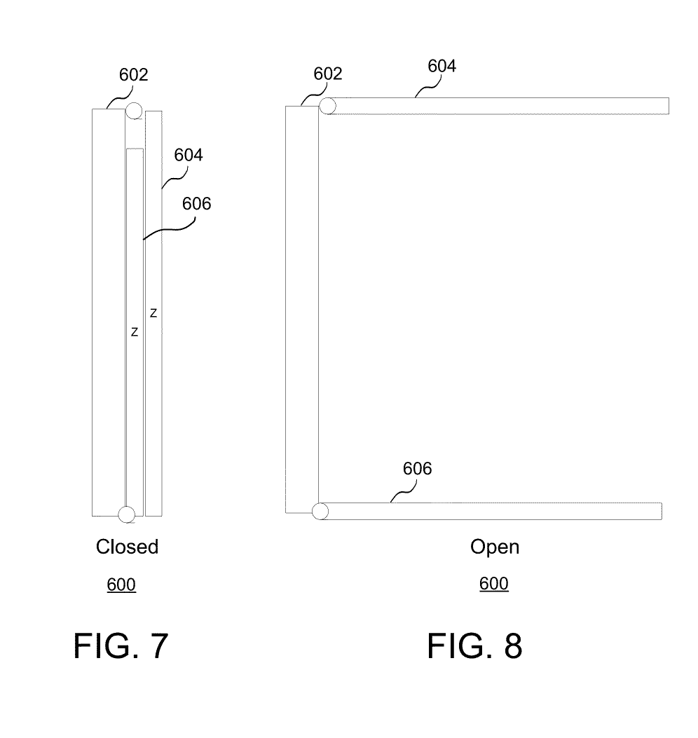

FIG. 7 illustrates a top view of primary and secondary displays 602, 604, and 606 of computer 600 of FIG. 6, where secondary displays 604 and 606 are in closed positions, according to one embodiment. FIG. 8 illustrates a top view of primary and secondary displays 602, 604, and 606 of computer 600 of FIG. 1, where secondary displays 604 and 606 are in open positions, according to one embodiment.

In one embodiment, the combination of primary display 602 and secondary displays 604 and 606 may be referred to as a dual-panel tri-fold display. In one embodiment, secondary displays 604 and 606 fold across primary display 602 when in closed positions. In this embodiment, the user opens both secondary displays 604 and 606 to use the computer. In this embodiment, the dual display positions and dimensions are fixed variables, which the screen management application 410 may take into account when creating the extended work area.

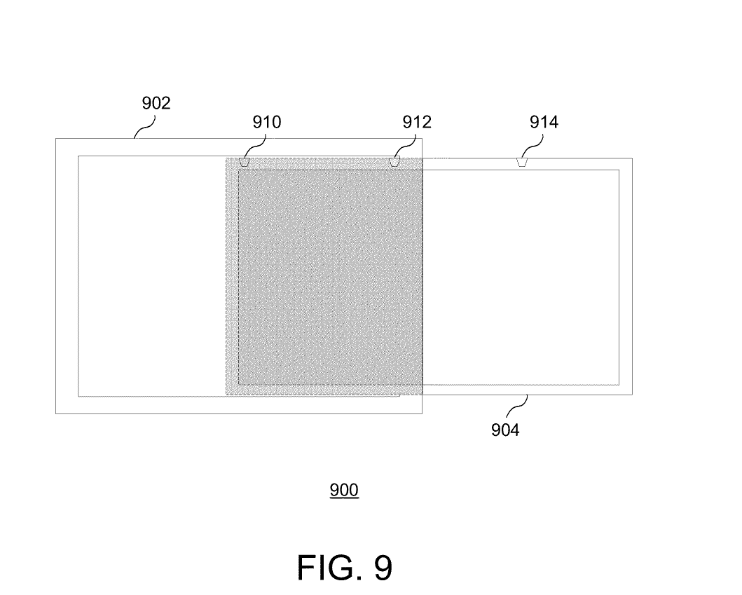

FIG. 9 illustrates a front view of an example extendable display area 900, according to one embodiment. In one embodiment, extendable display area 900 includes a primary display 902, a secondary display 904, and fixed-position catch locks 910, 912, and 914.

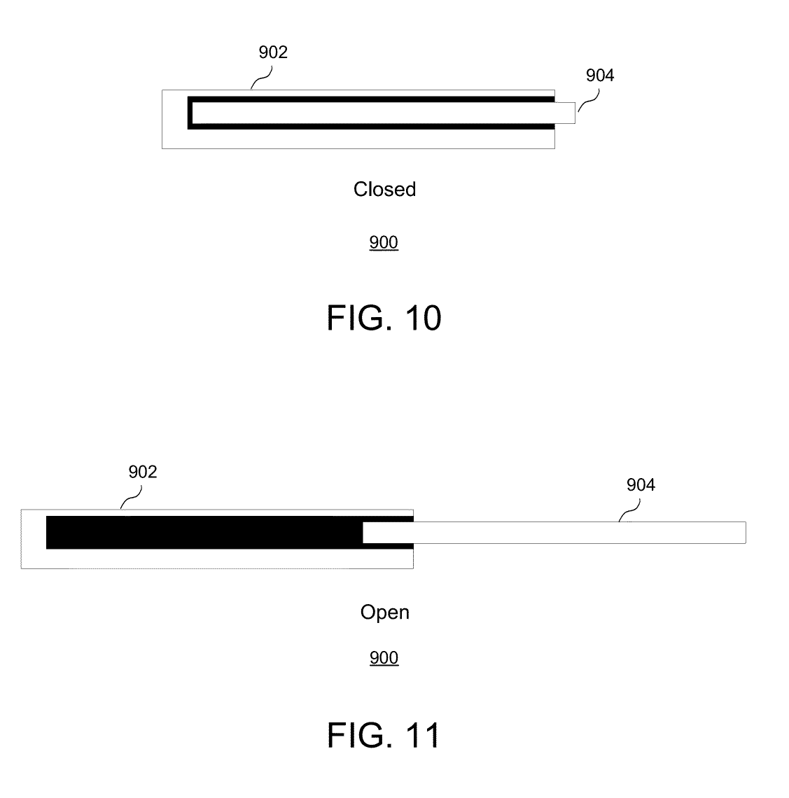

FIG. 10 illustrates a top view of primary and secondary displays 902 and 904 of display area 900 of FIG. 9, where secondary display 904 is in a closed position, according to one embodiment. FIG. 11 illustrates a top view of primary and secondary displays 902 and 904 of display area 900 of FIG. 9, where secondary display 904 is in an open position, according to one embodiment.

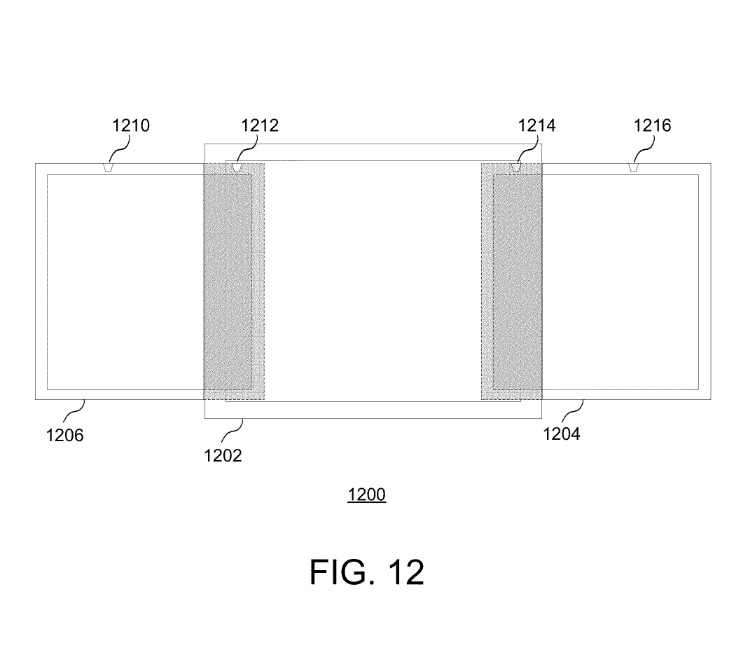

In one embodiment, the combination of primary display 902 and secondary display 604 may be referred to as a single-panel pocket mechanical display. In one embodiment, secondary display 904 slides into a pocket behind primary display 902. In one embodiment, the user pulls out the secondary display 904 when needed. In one embodiment, the display dimensions are fixed variables. In one embodiment, fixed-position catch locks 910, 912, and 914 enable the user to pull secondary display 904 out to predetermined positions. In one embodiment, the predetermined positions may be hard coded as parameters, which screen management application 410 may take into account when creating the extended work area. For example, in one embodiment, each of fixed-position catch locks 910, 912, and 914 may be associated with a different position. In one embodiment, each different position may be hard coded with the size of the resulting extended display area, or the size of the portion of secondary display 904 that is exposed, or the distance/width of secondary display 904 that is exposed. Screen management application 410 may then compute the size of the resulting extended display area as needed. In either of these embodiments, the size of the resulting extended display area would be, for example, the size of primary display 902 plus the size of the portion of secondary display 904 that is exposed, which would be predetermined or calculated, and associated with the given position. These examples may be applied to other embodiments where there are two secondary displays, as described below in connection with FIGS. 12 to 14.

FIG. 12 illustrates a front view of an example extendable display area 1200, according to one embodiment. In one embodiment, extendable display area 1200 includes a primary display 1202, secondary displays 1204 and 1206, and fixed-position catch locks 1210, 1212, 1214, and 1216.

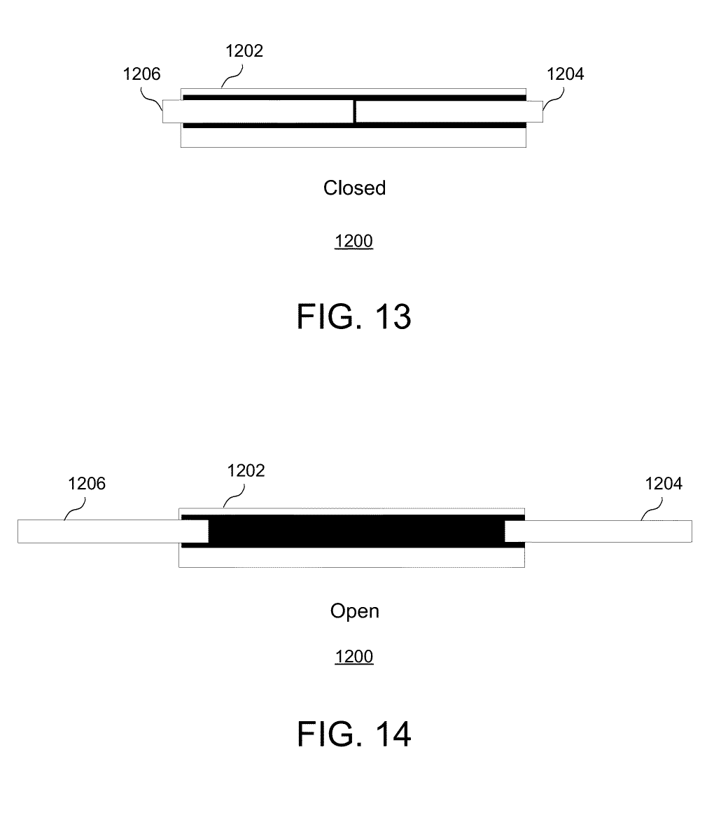

FIG. 13 illustrates a top view of primary and secondary displays 1202, 1204, and 1206 of display area 1200 of FIG. 12, where secondary displays 1204 and 1206 are in closed positions, according to one embodiment. FIG. 14 illustrates a top view of primary and secondary displays 1202, 1204, and 1206 of display area 1200 of FIG. 12, where secondary displays 1204 and 1206 are in open positions, according to one embodiment.

In one embodiment, the combination of primary display 1202 and secondary displays 1204 and 1206 may be referred to as a dual-panel pocket mechanical display. In one embodiment, secondary displays 1204 and 1206 operate similarly to secondary display 904 described above.

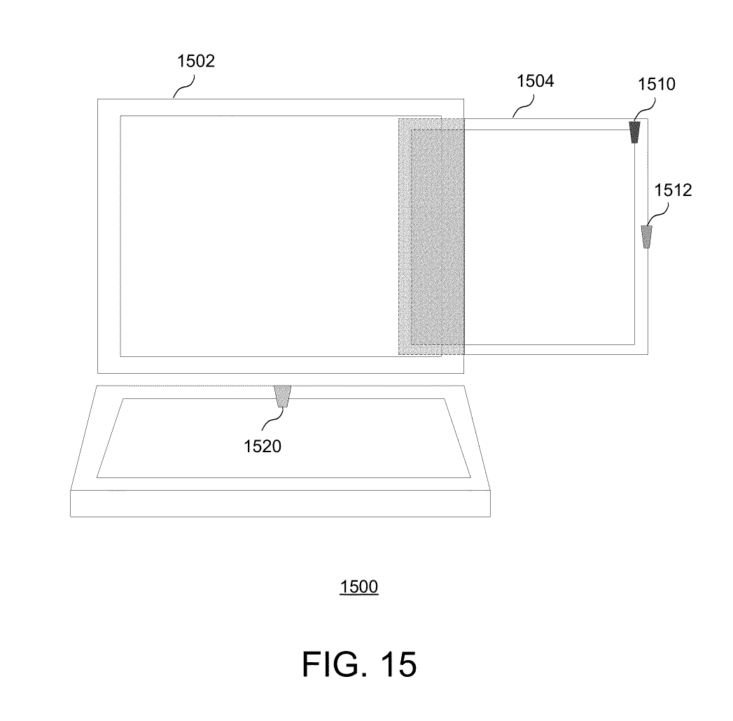

FIG. 15 illustrates a front view of an example computer 1500 having an extendable display area, according to one embodiment. In one embodiment, computer 1500 includes a primary display 1502 and a secondary display 1504, a range sensor 1510, a touch-activation sensor 1512, and a fixed-position sensor 1520.

In one embodiment, the combination of primary display 1502 and secondary display 1504 may be referred to as a single-panel pocket sensor display. In one embodiment, secondary display 1504 slides into a pocket behind primary display 1502. In one embodiment, the user pulls out secondary display 1504 when needed. In one embodiment the display dimensions are fixed variables. In one embodiment, range sensor 1510 may be employed to enable the user to have a completely dynamic extendable workspace. In one embodiment, touch-activation sensor 1512 and range sensor 1510 are located on the external edge of secondary display 1504. In one embodiment, touch-activation sensor 1512 may indicate to screen management application 410 when the position of secondary display 1504 is being modified, and range sensor 1510 may indicate to screen management application 410 how much the position of secondary display 1504 has changed. In one embodiment, the touch-activation sensor 1512 is activated by pressure or heat from a user's thumb or finger when the user grabs secondary display 1504 to pull it out. Also, range sensor 1510 scans the distance from range sensor 1510 to fixed-position sensor 1520. In one embodiment, using an algorithm, screen management application 410 may determine how far secondary display 1504 has been extended relative to primary display 1502. This may be determined using the distance variable determined by range sensor 1510, the known location of fixed-position sensor 1520, and the known dimensions of primary and secondary displays 1502 and 1504. Screen management application 410 uses this determination to adapt the user interface and/or application that the user is using to the extended display area.

In one embodiment, screen management application 410 may apply the following formula to determine an extended display area. In one embodiment, the extended display area may be centered vertically on primary display 1502 at a height of the primary display 1502 resolution.

Extended display area=H×W, where W=P+(R−(P−F)), where

H=Height of the primary display as a fixed distance from the range sensor or a fixed height from a predetermined location on the chassis of the primary display; W=Total width of available display desktop; P=Total width of the primary display; R=Range sensor distance to a fixed position (e.g., to fixed-position sensor); and F=Fixed-position sensor in relation to the center of the primary display (e.g., to fixed-position sensor). In one embodiment, screen management application 410 then determines the extended workspace resolution based on the resolution of the primary display. For example, a 1920×1080 primary display might have a 50% increase in workspace width. As such, the displayed resolution on the secondary display would be 1920×540.

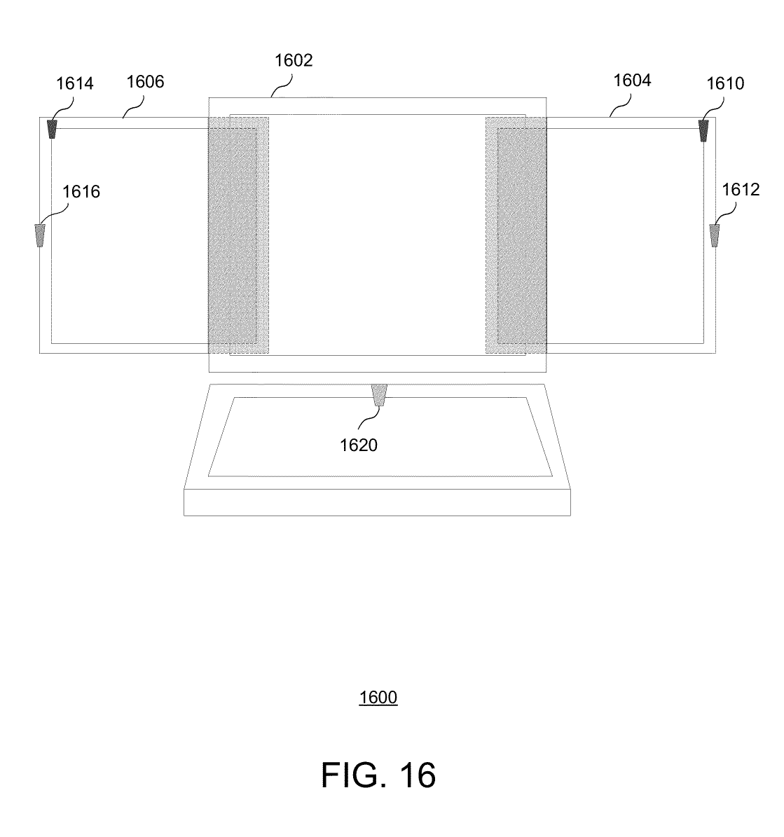

FIG. 16 illustrates a front view of an example computer 1600 having an extendable display area, according to one embodiment. In one embodiment, computer 1600 includes a primary display 1602, secondary displays 1604 and 1606, range sensors 1610 and 1614, touch-activation sensors 1612 and 1616, and a fixed-position sensor 1620.

In one embodiment, the combination of primary display 1602 and secondary displays 1604 and 1606 may be referred to as a dual-panel pocket sensor display. In one embodiment, screen management application 410 may apply the following formula to determine an extended display area. In one embodiment, the extended display area may be centered vertically on primary display 1602 at a height of the primary display 1602 resolution, where the position of the primary display 1602 is fixed.

Extended display area=H×W, where W=P+(R−(P−F))+(L−(P−F)), where

H=Height of the primary display as a fixed distance from the range sensor or a fixed height from a predetermined location on the chassis of the primary display; W=Total width of available display desktop; P=Total width of the primary display; R=Right range sensor distance to a fixed position (e.g., to fixed-position sensor or left range sensor); L=Left range sensor distance to a fixed position (e.g., to fixed-position sensor or right range sensor); and F=Fixed-position sensor in relation to the center of the primary display (e.g., to fixed-position sensor).

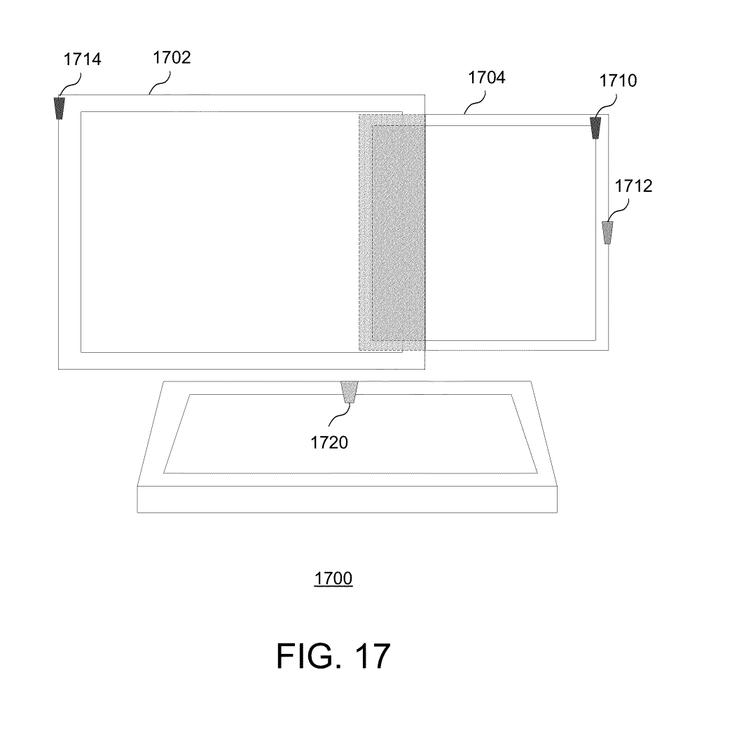

FIG. 17 illustrates a front view of an example computer 1700 having an extendable display area, according to one embodiment. In one embodiment, computer 1700 includes a primary display 1702, a secondary display 1704, range sensors 1710 and 1714, a touch-activation sensor 1712, and an optional fixed-position sensor 1720.

In one embodiment, the combination of primary display 1702 and secondary display 1704 may be referred to as a primary and secondary sliding panel pocket sensor display. In one embodiment, primary display 1702 and secondary display 1704 slide in independent directions, and the adjusting of the settings of secondary display 1704 is based on the position of secondary display 1704 relative to the position of primary display 1702. A detailed example is described below.

In one embodiment, screen management application 410 may apply the following formula to determine an extended display area. In one embodiment, the extended display area may be centered vertically on primary display 1702 at a height of primary display 1702 resolution.

Extended display area=H×W, where W=P+S, where S=(R+L)−P, and where

H=Height of the primary display as a fixed distance from the range sensor or a fixed height from a predetermined location on the chassis of the primary display; W=Total width of available display desktop; P=Total width of primary display; R=Right range sensor distance to a fixed distance (e.g., to fixed-position sensor or left range sensor); L=Left range sensor distance to a fixed distance (e.g., to fixed-position sensor or right range sensor); S=Secondary display width available for display.

In one embodiment, fixed-position sensor 1720 may be used to determine the offset of the primary display 1702 for purposes of centering the desktop display horizontally. In one embodiment, the combination of primary display 1702 and secondary display 1704 may be referred to as a primary and secondary sliding panel sensor display, where primary display 1702 and secondary display 1704 slide in independent and/or opposite directions. In one embodiment, the user opens the extra display when needed. In one embodiment, the display dimensions are fixed variables. This is a similar situation to the previous embodiment described in FIG. 16. In one embodiment, range sensors can be employed to allow the user to have a completely dynamic extendable workspace. In one embodiment, fixed-position sensor 1720 may be located in any suitable location (e.g., the housing of primary display 1702 or secondary display 1704), and touch-activation sensor 1712 and range sensor 1710 and 1714 may be located on the external edges of both respective primary and secondary displays 1702 and 1704. In one embodiment, touch-activation sensor 1712 may indicate to screen management application 410 when the positions of each of the displays 1702 and/or 1704 are being modified, and range sensors 1710 and 1714 may indicate to screen management application 410 how much the positions of displays 1702 and/or 1704 have been modified. In one embodiment, range sensors 1710 and 1714 scan for the distance from each other. In one embodiment, range sensors 1710 and 1714 scan for the distance from each respective range sensor to fixed-position sensor 1720. With any of these embodiments, screen management application 410 may use an algorithm to determine the size of the combined displays (e.g., resulting extended display area). In one embodiment, screen management application 410 may make such a determination using the distance variable determined by triangulating range sensors 1710 and 1714 on the known location of fixed-position sensor 1720, and the known dimensions of the secondary and primary displays 1702 and 1704. This determination could be used by screen management application to adapt the user interface and/or application that the user is using to the extended display area.

In one embodiment, screen management application 410 may perform power-saving functions. For example, in one embodiment, screen management application 410 may display black (e.g., turn off pixels) at the portions of the secondary display(s) that are hidden (e.g., a portion that is still inside a primary display pocket).

Although the description has been described with respect to particular embodiments thereof, these particular embodiments are merely illustrative, and not restrictive. For example, in the embodiments described above, one or two secondary displays have been described. Other embodiments are possible where there are more than two secondary displays. Any suitable programming language can be used to implement the routines of particular embodiments including C, C++, Java, assembly language, etc. Different programming techniques can be employed such as procedural or object-oriented. The routines can execute on a single processing device or multiple processors. Although the steps, operations, or computations may be presented in a specific order, this order may be changed in different particular embodiments. In some particular embodiments, multiple steps shown as sequential in this specification can be performed at the same time.

Particular embodiments may be implemented in a computer-readable storage medium (also referred to as a machine-readable storage medium) for use by or in connection with the instruction execution system, apparatus, system, or device. Particular embodiments can be implemented in the form of control logic in software or hardware or a combination of both. The control logic, when executed by one or more processors, may be operable to perform that which is described in particular embodiments.

A “processor” includes any suitable hardware and/or software system, mechanism or component that processes data, signals or other information. A processor can include a system with a general-purpose central processing unit, multiple processing units, dedicated circuitry for achieving functionality, or other systems. Processing need not be limited to a geographic location, or have temporal limitations. For example, a processor can perform its functions in “real time,” “offline,” in a “batch mode,” etc. Portions of processing can be performed at different times and at different locations, by different (or the same) processing systems. A computer may be any processor in communication with a memory. The memory may be any suitable processor-readable storage medium, such as random-access memory (RAM), read-only memory (ROM), magnetic or optical disk, or other tangible media suitable for storing instructions for execution by the processor.

Particular embodiments may be implemented by using a programmed general purpose digital computer, by using application specific integrated circuits, programmable logic devices, field programmable gate arrays, optical, chemical, biological, quantum or nanoengineered systems, components and mechanisms may be used. In general, the functions of particular embodiments can be achieved by any means as is known in the art. Distributed, networked systems, components, and/or circuits can be used. Communication, or transfer, of data may be wired, wireless, or by any other means.

It will also be appreciated that one or more of the elements depicted in the drawings/figures can also be implemented in a more separated or integrated manner, or even removed or rendered as inoperable in certain cases, as is useful in accordance with a particular application. It is also within the spirit and scope to implement a program or code that can be stored in a machine-readable medium to permit a computer to perform any of the methods described above.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

While one or more implementations have been described by way of example and in terms of the specific embodiments, it is to be understood that the implementations are not limited to the disclosed embodiments. To the contrary, it is intended to cover various modifications and similar arrangements as would be apparent to those skilled in the art. Therefore, the scope of the appended claims should be accorded the broadest interpretation so as to encompass all such modifications and similar arrangements.

Thus, while particular embodiments have been described herein, latitudes of modification, various changes, and substitutions are intended in the foregoing disclosures, and it will be appreciated that in some instances some features of particular embodiments will be employed without a corresponding use of other features without departing from the scope and spirit as set forth. Therefore, many modifications may be made to adapt a particular situation or material to the essential scope and spirit.

What is claimed is:

1. A method comprising:
detecting a first position of a secondary display relative to a primary display;
detecting a second position of the secondary display; and
adjusting one or more settings of the secondary display based on the second position, wherein the adjusting causes the secondary display to be a continuation of the primary display.

2. The method of claim 1, further comprising adjusting one or more second settings associated with each of a plurality of secondary displays based on respective second positions associated with each of the secondary displays.

3. The method of claim 1, wherein the secondary display slides into and out of a pocket behind the primary display.

4. The method of claim 1, wherein a plurality of secondary displays slide into and out of a pocket behind the primary display.

5. The method of claim 1, wherein the primary display and the secondary display slide in independent directions, and wherein adjusting the one or more settings of the secondary display is based on the second position of the secondary display relative to a position of the primary display.

6. The method of claim 1, wherein adjusting the one or more settings comprises adjusting one or more extended desktop settings.

7. The method of claim 1, wherein adjusting the one or more settings comprises adjusting at least one software application that a user is using to continuously span across both the primary display and the secondary display.

8. A computer-readable storage medium carrying one or more sequences of instructions, the instructions when executed by a processor cause the processor to:
detect a first position of a secondary display relative to a primary display;
detect a second position of the secondary display; and
adjust one or more settings of the secondary display based on the second position, wherein the adjusting causes the secondary display to be a continuation of the primary display.

9. The computer-readable storage medium of claim 8, wherein the instructions further cause the processor to adjust one or more second settings associated with each of a plurality of secondary displays based on respective second positions associated with each of the secondary displays.

10. The computer-readable storage medium of claim 8, wherein the secondary display slides into and out of a pocket behind the primary display.

11. The computer-readable storage medium of claim 8, wherein a plurality of secondary displays slide into and out of a pocket behind the primary display.

12. The computer-readable storage medium of claim 8, wherein the primary display and the secondary display slide in independent directions, and wherein adjusting the one or more settings of the secondary display is based on the second position of the secondary display relative to a position of the primary display.

13. The computer-readable storage medium of claim 8, wherein the instructions further cause the processor to adjust one or more extended desktop settings.

14. The computer-readable storage medium of claim 8, wherein the instructions further cause the processor to adjust at least one software application that a user is using to continuously span across both the primary display and the secondary display.

15. An apparatus comprising:
one or more processors; and
logic encoded in one or more tangible media for execution by the one or more processors and when executed operable to:
detect a first position of a secondary display relative to a primary display;
detect a second position of the secondary display; and
adjust one or more settings of the secondary display based on the second position, wherein the adjusting causes the secondary display to be a continuation of the primary display.

16. The apparatus of claim 15, wherein the logic when executed is further operable to adjust one or more second settings associated with each of a plurality of secondary displays based on respective second positions associated with each of the secondary displays.

17. The apparatus of claim 15, wherein the secondary display slides into and out of a pocket behind the primary display.

18. The apparatus of claim 15, wherein a plurality of secondary displays slide into and out of a pocket behind the primary display.

19. The apparatus of claim 15, wherein the primary display and the secondary display slide in independent directions, and wherein adjusting the one or more settings of the secondary display is based on the second position of the secondary display relative to a position of the primary display.

20. The apparatus of claim 15, wherein the logic when executed is further operable to adjust one or more extended desktop settings.
